(19) United States
(12) Patent Application Publication
(10) Pub. No.: US 2011/0153400 A1
(43) Pub. Date: Jun. 23, 2011

(54) METHOD OF PRODUCT PRICE PROMOTION

(76) Inventor: Rod Nimrode Averbuch, Chicago, IL (US)

(21) Appl. No.: 12/643,311

(22) Filed: Dec. 21, 2009

(51) Int. Cl. G06Q 30/00; G06Q 10/00; G06Q 90/00; G06F 17/30; H04Q 5/22

(52) U.S. Cl. 705/14.25; 40/299.01; 705/28; 705/500; 707/609; 340/10.1; 707/769; 707/E17.014; 707/E17.005

(57) ABSTRACT

A method of product price promotion, which is based on allocating a plurality of Cycled Discount Labels to product types and labeling a plurality of product type members. Cycled Discount Labels are associated with product type member lots. The price promotion option for each product type member, which is associated with a Cycled Discount Label, is calculated and presented to the consumer. The price promotion option for a product type member is further discounted as the product type member approaches its expiration date.

### CROSS-REFERENCE TO RELATED APPLICATIONS

U.S. Pat. No. 7,464,873 Method of managing expiration dated product inventories (Spencer, et al.)
U.S. Pat. No. 6,298,331 Method and apparatus for selling an aging food product (Walker, et al.)
US2004/0186783 Time sensitive inventory sale system (Knight, et al.)
U.S. Pat. No. 4,973,952 Shopping cart display system (Malec, et al.)

### BACKGROUND OF THE INVENTION

Most of the products in supermarkets have an associated lifetime. In order to avoid waste, it is common practice to manually re-label discount representations for subsets of products approaching their expiration date. Manual re-labeling is very limited because it requires intensive labor associated with identifying specific subsets of products and labeling every promoted item. Warehouse and storage facility based inventory management techniques for large volumes of packaged products, which are based on each product's expiration date, are known in the art. One example is “Method of managing expiration dated product inventories U.S. Pat. No. 7,464,873.” Large volume inventory management is feasible at storage facilities as large amounts of the same product from the same lot are packed together. Therefore, it is reasonable to use computerized systems to identify and monitor the product lots. These techniques do not translate to re-labeling thousands of loose products with a mix of expiration dates, which cannot easily and effectively be identified and managed in this way. Therefore, such an approach is not realistic in a supermarket environment. Some limited automatic product price reduction procedures are also known in the art. These procedures involve a specific pricing calculation and price display for each product as claimed in “Method and apparatus for selling an aging food product U.S. Pat. No. 6,298,331”. In this art, the price is calculated for each cooked product based on a timer that starts when the product is placed on a warming bin and anticipated expiration time. The price is than presented on a point of sale terminal for each product.

In a supermarket environment there are thousands of relatively inexpensive items. Every product type is comprised of a mix of product type members with differing shelf lives. Therefore, having a price presentation on a point of sale display for every product type member of every product type is not realistic. Furthermore U.S. Pat. No. 6,298,331 does not demonstrate a method to explicitly distinguish between different member of the same product type with different expiration dates.

General promotion of product items based on expiration date is also well-known in the art. “Time sensitive inventory sale system US2004/0186783” proposes such a system.

This system proposes enhancement of display techniques of promoted products on a point of sale display device. In this invention, a computer identifies items that are candidates for promotion. One of the considerations is the item's expiration date. The invention claims special item enhancement presentation techniques in order to underline the promotion of these items. Special multimedia enhancement techniques are claimed in the art, such as: enhanced colors, special animation, and preferred location on the screen.

This invention does not demonstrate a technique to identify and distinctly promote subsets of the same product with different expiration dates, which are placed at the same location. Therefore, this technique would not perform properly in a supermarket environment where items of the same type with different expiration dates are mixed on the same shelf. Enhanced promotional display and pricing of lists of items does not provide the consumer with specific identification and promotion information of subsets of items with mixed lifetimes.

Displaying product type pricing and related promotions in proximity to a consumer's shopping cart is also described in “Shopping cart display system U.S. Pat. No. 4,973,952”. Cart-located display devices show general information, including price promotion, related to product types surrounding the cart. However, the display device cannot distinguish between different lots of the same product type at a given location. The consumer in this case is unable to differentiate between price promotion options of a single product type at the same location with different remaining lifetimes.

### SUMMARY OF THE INVENTION

This invention is a method of price promotion that targets but is not limited to a supermarket environment, which contains thousands of product types from different lots. Each product type display location may have items with different production dates. This invention eliminates the need for product re-labeling and large amounts of display equipment. The invention proposes a new cycling labeling scheme associated with different members of the same product type from different lots. A display device provides the linkage between the cycled discount labels on the product members and the product member dynamic pricing. The invention does not require re-labeling of products for a new price promotion offering. The management of this system is mostly automated with minimal manual labor. Furthermore, supermarket consumers will appreciate the empowerment to dynamically select members of product types based on their remaining lifetimes and associated dynamic promotional prices.

For example, different items of a cheese product with the same packaging and location can dynamically be offered with distinct price promotions. The offered price promotions are based on the remaining lifetime of each individual cheese package. A large family could consume a large package of cheese in few days. Therefore, easily identifying a price-reduced large cheese package item in the last week of its lifetime is a great value for a consumer with a large family. Dynamic pricing potentially reduces waste, which can increase profit and has a positive environmental impact.

### BRIEF DESCRIPTION OF THE FIGURES

FIG. 1 is a block diagram of product price promotion system elements and associated interfaces in accordance with some embodiments

FIG. 2A is an example of Cycled Discount Labeling technique, which could be implemented for product price promotion system in accordance with some embodiments

FIG. 2B is an example of another Cycled Discount Labeling technique, which could be implemented for product price promotion system in accordance with some embodiments

FIG. 3 is a display example of Cycled Discount Labeling price promotion options on a display device. A Cycled Discount Label, which is used for inventory shelf management, is also illustrated in accordance with some embodiments

FIG. 4 is a flowchart of the product price promotion technique, which describes product labeling, display devices and promotion server functionality in accordance with some embodiments

FIG. 5A is a flow chart of the product price promotion technique illustrating the update of the promotion database with new price promotion information in accordance with some embodiments

FIG. 5B is a flow chart of the product price promotion technique illustrating the product query operation at the cash register in accordance with some embodiments

FIG. 6 is a flowchart of product price promotion recommendation technique associated with Cycled Discount Labels in accordance with some embodiments

FIG. 7 is a product recommendation record table example used by the price promotion recommendation technique for calculating the recommended product types associated with specific Cycled Discount Labels in accordance with some embodiments

FIG. 8 is a database record example of the promotion database illustrating the associated information between store ID, product type ID, and related discount and Cycled Discount Labels in accordance with some embodiments

FIG. 9A is an example that illustrates the promotion states selection and the linear wasting probability vs. time of two product members associated with two Cycled Discount Labels in accordance with some embodiments

FIG. 9B is an example of statistical data presentation of time between purchases of product type, which is used to calculate the number of promotion states in accordance with some embodiments

FIG. 10 illustrates a message chart between product price promotion system elements in accordance with some embodiments

### DETAILED DESCRIPTION

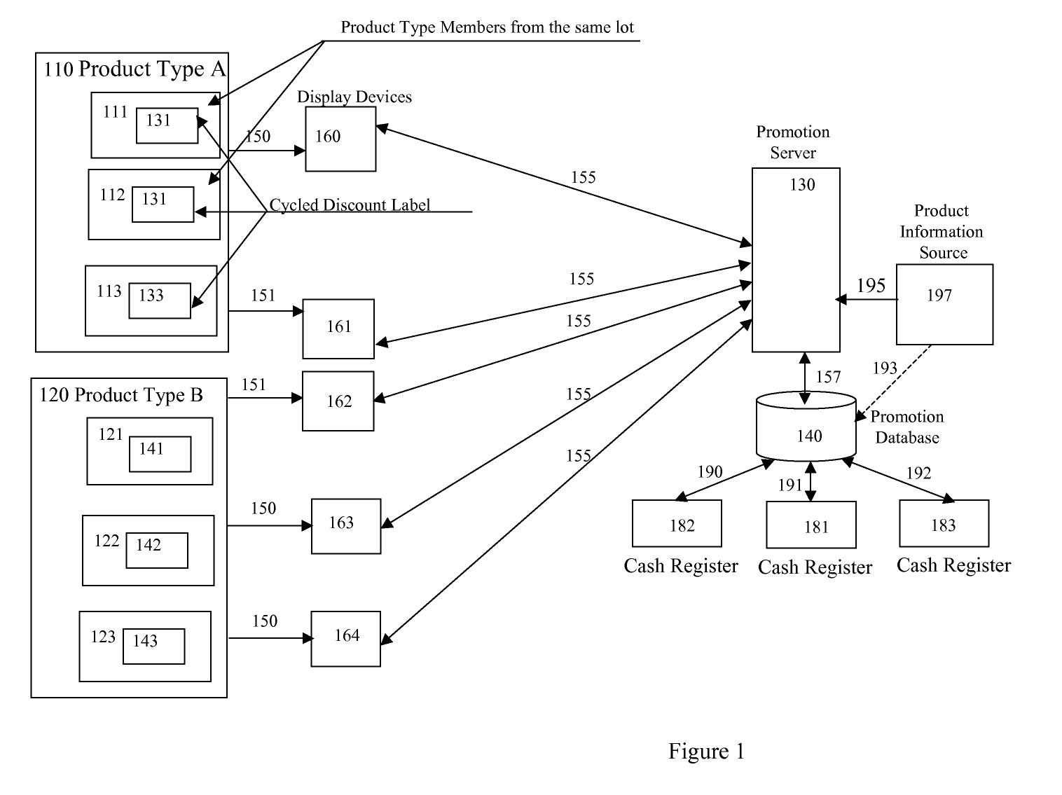

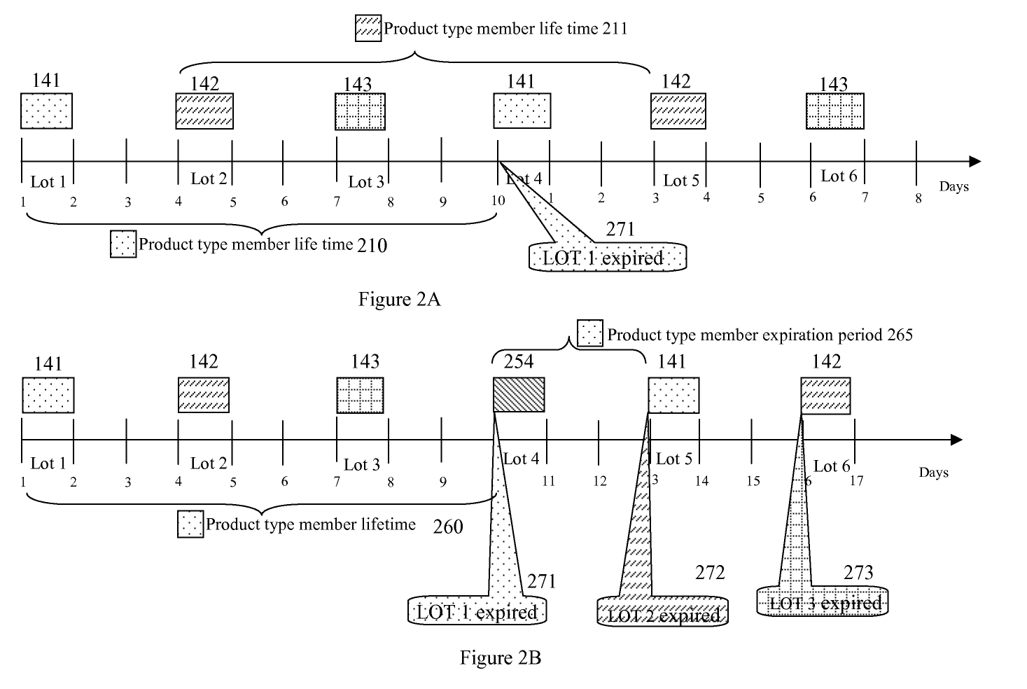

FIG. 1 illustrates products price promotion system elements and associated interfaces. A plurality of different Product Types (PTs) 110, 120 such as cheese packages or sardine cans are illustrated. Each product type is comprised of Product Type Members (PTMs) 111, 112, 113, 121, 122, 123. Each PTM has the same exact PT characteristics (i.e. package, manufacturer, weight, ingredients, process, etc.). However, different PTMs from the same PT could be associated with different production times. A plurality of PTMs from a plurality of PTs is placed on a supermarket's shelves. In FIG. 1, PTMs 111, 112 are a subset of PTMs of the same PT and from the same lot. Therefore, they are labeled with identical Cycled Discount Labels (CDLs) 131. A lot is defined as one or more consecutive production batches of PTMs from the same PT. A batch could be also associated with the same pickup date of natural PTs such as fruits or vegetables. CDLs 131, 133, 141, 142, 143 are visual labels that are placed on each PTM. The “cycled” term of CDL is defined such that an identical CDL could be used for PTMs of the same PT from different lots. The reuse of an identical CDL is allowed as long as the time passed since the last use of the CDL for the given PT is equal or greater than PT lifetime. Each CDL represents one price promotion option for PTMs associated with a specific PT lot. The price promotion associated with each CDL is dynamically offered to a consumer, yet the CDL on the PTMs does not change. The number of available CDLs for each PT is individually determined, by marketing and consumer survey data, which indicate the preferred selection options for a specific PT to consumers. Examples of CDL reuse techniques are illustrated in FIG. 2A and FIG. 2B.

A CDL is a label that is distinguished by a different color or pattern or a combination of the two. The Display Devices (DDs) in FIG. 1 are numbered as: 160, 161, 162, 163 and 164. The DD shows a representation of at least a single PT its in proximity. The PT representation could consist of an image or related text. The DD also displays color or pattern representing of a set of CDLs that are associated with the displayed PTs. Price promotion and remaining lifetime of PTMs that are associated with a CDL are also displayed on the DD. The DD could be implemented as an active device while the display content is dynamically changed. An example of such devices is a stationary DD such as a PC based display or mobile DD such as Nokia 3220. An active stationary DD could also be implemented as a kiosk that serves an area of PTs. The DD in another embodiment could be implemented as a passive DD. In such an implementation, a permanent paper or other material containing a printed presentation of a current time indication, PT presentation, associated CDLs, price promotion options and remaining life time of the PTMs is associated with each CDL. The interface 155 for the passive DD could be associated with the printer that prints the passive DD. Any DD related functionality described in this specification is for an active DD unless specifically defined as a passive DD. The Promotion Server (PS) 130 calculates the price promotion options and the remaining lifetime associated with each CDL from the CDL set allocated to the PT. Using interface 155, the PS then transmits to the DD the PT indication, PT associated CDL set, calculated price promotion of each CDL and remaining lifetime of the PTMs associated with each CDL. Interface 155 could be based on but is not limited to standard Internet protocols such as IP, TCP, UDP, HTTP or HTTPS. The PS 130 in this embodiment updates the Promotion Database (PDB) 140 with PTM related information that is associated with new lots via interface 157. The Cash Registers (CRs) 181, 182 and 183 also interface to the PDB in order to calculate the price promotion for any PTM. In another embodiment, the CRs read the already calculated price promotion options by the Promotion Server (PS) 130 from the PDB. Product Information Source (PIS) 197 is an entity that provides updated information related to PT and PTM lots such as: CDL types and numbers, lot information such as a lot's date for a specific PTM and associated store ID. Other information such as special promotion factors related to shelf space management and special promotion factors related to the introduction of a new version of PTs could also be provided by (PIS) 197. The PIS 197 could interface directly to PS via interface 195. PIS could also directly interface to PDB via interface 193. Both 195 and 193 interfaces could be based on but is not limited to Internet protocols such as IP, TCP, UDP, HTTP or HTTPS.

FIG. 2A illustrates a CDL technique example, which could be implemented in product price promotion system. In this example, there are three unique CDLs 141,142 and 143 that are allocated to a specific PT. Each different lot (1, 2, 3, 4, 5, 6) is associated with a specific CDL 141, 142, 143. In this example, every three days there is a new lot. The production of this lot lasts for a one day period and could consist of several consecutive production batches. After all 3 unique CDLs are used (three in this example) 141, 142, 143 for lot 1, 2, 3, an identical CDLs 141 is reused again for lot 4, 142 for lot 5 and 143 for lot 6. All PTMs have the same lifetime, which could also be defined as PTM lifetime 210, 211. An identical CDL is not used twice during a PTM lifetime in order to avoid confusion between different lots of the same PT. Therefore, an assumption in the FIG. 2A example is that when the lifetime expires for all PTMs from lot 1, they are removed from the shelves prior to placing a new PTM from lot 4. The same assumption applies to the PTMs from lots 2 and 3 before placing lots 5 and 6.

FIG. 2B illustrates another CDL technique example, which could be implemented in a product price promotion system. In this example the number of unique CDLs allocated to a Product Type PT is four: 141, 142, 143 and 254. The PT lifetime is the same as in FIG. 2A. CDL 254 is used for the labeling of the PTMs from the next lot, which is lot 4. Furthermore, CDL 254 also indicates that the PTMs which were previously labeled with CDL 141 are expired and have to be removed from shelves. In FIG. 2B, 265 is defined as the expiration period for PTMs from lot 1 which are labeled with CDL 141. CDL 141 is used again to label lot 5 and also to indicate that lot 2, which was previously labeled by CDL 142, is expired and needs to be removed from the shelves. The same labeling technique is applied to CDL 143. This technique has an advantage over the technique illustrated in FIG. 2A. The technique illustrated in FIG. 2B allows an extra time period between PTM end of life and the reuse of an identical CDL for the PTMs from different lot number. The additional CDL allows convenient removing of the expired PTMs from the shelf before PTMs from different lot with an identical CDL are placed on the shelf.

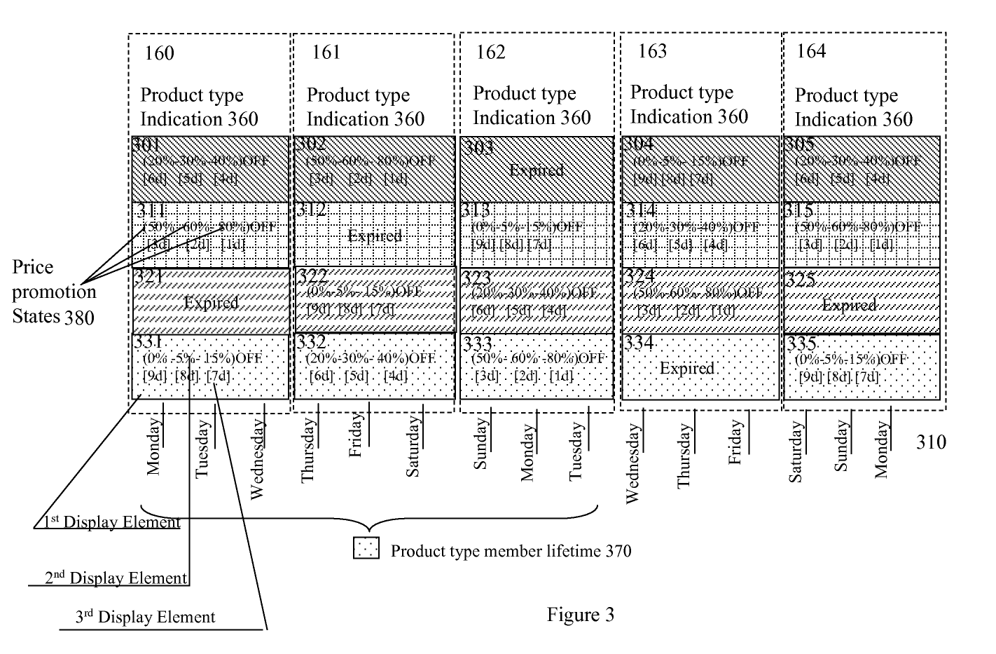

FIG. 3 illustrates DDs 160, 161, 162, 163 and 164 presentation examples of the CDLs, associated Price Promotion State (PPS) 380, PT indication 360 and the remaining lifetime of PTMs from the same lot. The DDs in this example present different price promotion options for PTMs associated with same CDLs during different days of the week. PPS 380 is defined as the state wherein the price promotion associated with the same CDL does not change. Different PPSs represent different price promotions. DD 160 displays five different Display Sections (DS)s 360 301, 311, 321 and 331 during 3 PPSs where each PPS lasts a day: Monday, Tuesday or Wednesday. All the DDs in FIG. 3 display the same PT indication 360 at different days of the PTM lifetime. The first DS 360 is a PT presentation. PT presentations could consist of an image or text describing the PT. Each DS 301, 311, 331 (of DD 160) in this example contains three Display Elements (DE)s. The first DE is the CDL, which is a unique color or pattern. DSs 331, 332, 333, 334 in this example are related to the same lot and have a unique CDL pattern representation of dots. DS 335 has the same dotted pattern but represents a different lot. DSs 311 and 312 in the example are related to the same lot having a unique CDL pattern of dotted squares. DSs 313, 314 and 315 have the same reused pattern as DS 311, 312; however, they represent a different lot. The second DE presents the PPSs during Monday, Tuesday and Wednesday. Monday is the first day of this lot. Therefore, the PPS presented by the second DE on DS 331 will not show a price reduction on this day. This is because the PTM that is associated with this PPS is at the first day of its life. On Tuesday, the PPS presented by the second DE indicates 5% OFF as the remaining PTMs' lifetimes are shorter by one day. On Wednesday, the PPS presented by the second DE indicates 15% OFF as the remaining PTMs' lifetimes. As the PTMs' lifetimes approach the expiration date, the price promotion that is presented by the second DE is further reduced. If a lot is a combination of several batches, then the expiration date of the lot is determined by the earliest batch. On Tuesday, the DD 162 in the second DE PPS of DS 333 shows 80% OFF the basic price. The reason for this price promotion is that the PTMs, which are labeled with a dotted pattern, are about to expire. Axis 310 is the time axis, which is marked by weekdays. CDL of DS 334 represents the expiration period of the PTMs that are labeled with this CDL.

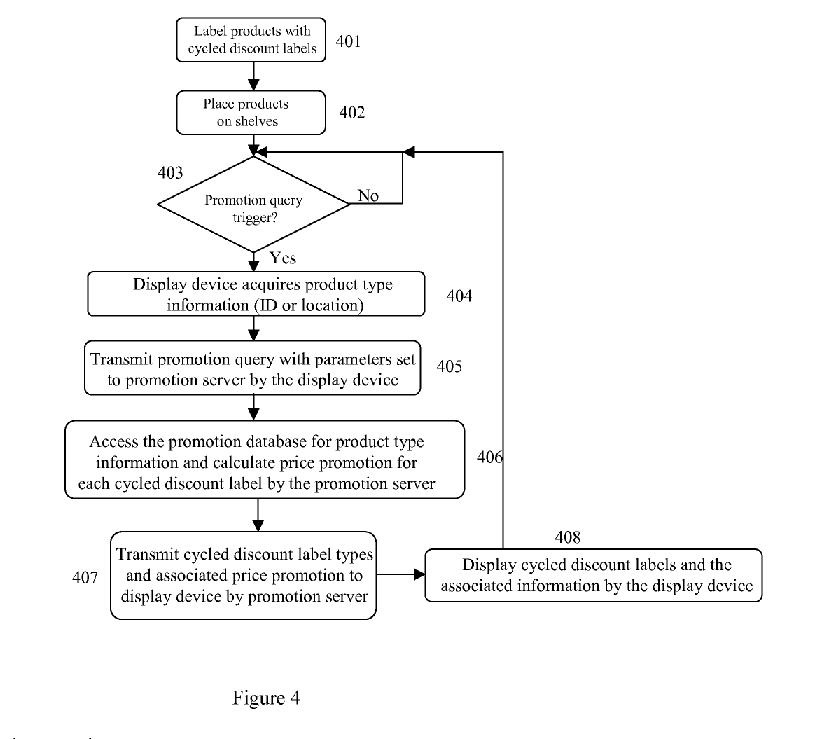

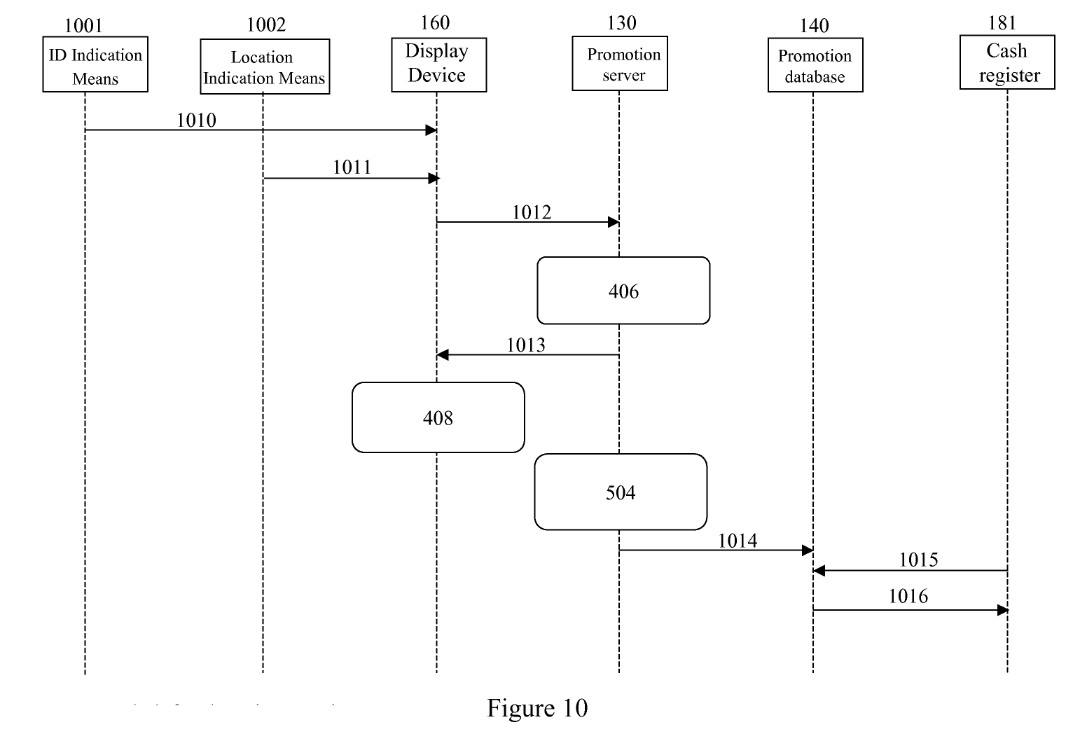

FIG. 4 is a flow chart example of the product price promotion technique. FIG. 4 is discussed together with FIG. 10, which illustrates the message chart between the product price promotion elements. On step 401, the PTMs of the same PT and from the same lot are labeled with unique CDLs. Manufactured product packages of the same PT and from different lots would have different printed CDLs, as illustrated and described in FIG. 2A and FIG. 2B. Fresh products such as vegetables or fruit could be applied with discount label stickers of CDLs representing their pickup dates. The CDL selection and display techniques are describes in details on FIG. 2A, FIG. 2B and FIG. 3. On step 402, the products are placed on the shelves. On step 403, the DD (160, 162, 162,163 or 164) waits for a price promotion query trigger. The consumer could initiate the trigger by manually entering PT ID. The trigger could be automatically initiated by the location change of a mobile DD. The location change of the mobile DD in this case is determined by different means. A store location system that is based on standard WiFi could be utilized by the DD. In this case the DD has to be equipped with WiFi receiver, processor memory and location application client. Another way to determine the location change by the DD is by receiving a local location indication from a standard short range RF device such as a Bluetooth or RFID device. These devices could be placed in several locations in the supermarket. The DD constantly compares the last two location indications in order to determine a location change. Location indication could consist of store X,Y coordinates or aisle number and a distance from the beginning of the aisle.

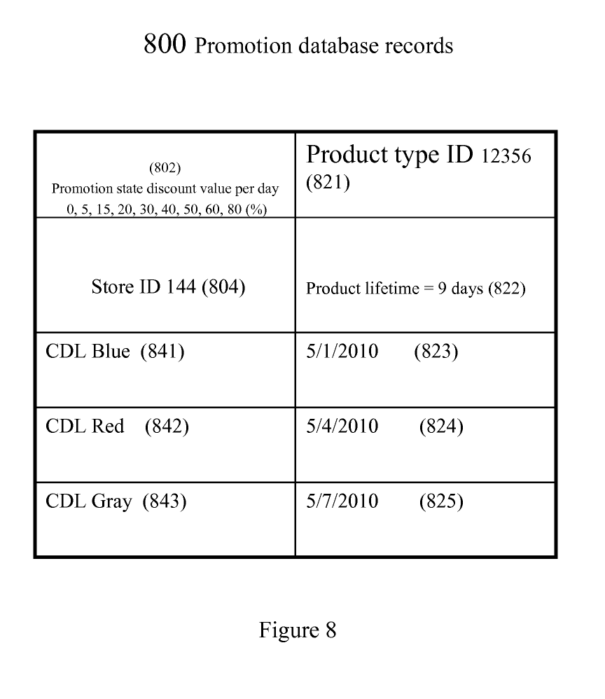

The location of the DD could also be determined at the display device by the reception of PT ID indication in proximity to the DD. PT ID indication combined with store ID indicate a specific location of the PT in the store. The store ID could be added to every PT ID RFID message. In another embedment, a centralized store ID transmitter that could be located at the entrance door of the store provides the store ID indication. The store ID indication could be used for identifying the same CDL from different lots in different stores. In this embodiment field 804 in FIG. 8 is used to identify the store. In both embodiments, the DDs have to be equipped with the proper standard RF receiver, processor memory and software client.

On step 404, the DD acquirers the information of the PT in the proximity to the DD. At least PT ID or PT location information is required for the PT price promotion options query. The PT ID could be manually entered via the DD keyboard or touch screen. The PT ID could be automatically acquired by a standard optical scanning technique, such as a barcode scanner, or by RF means. The RF means could be implemented as a standard passive RF device, which does not contain a power supply, such as a RFID device. In this case the DD has to be equipped with a standard RF means to support RFID information reception. Other RF means are standard active RFID, Bluetooth or WiFi transmitters in proximity to the PT.

A centralized location system in the supermarket could be the means for DD location calculation. The PT location or the DD location can be the only parameters provided by the DD in addition to store ID. In this case the Promotion Server (PS) needs to have the means to translate the location to a PT ID at a specific store. The translation means could be a table that maps a specific location in the store to PT ID. Message 1010, containing PT ID, and 1011, containing location indication, to the DD are illustrated in FIG. 10. Location indication could consist of store X,Y coordinates or aisle number and a distance from the beginning of the aisle. Several PTs could be present in proximity to this location. In this case, the price promotion options associated with the CDLs for these PTs are provided to the DD by the PS. In step 405, the DD sends a price promotion options set query to the PS. The DD utilizes query message 1012, as illustrated in FIG. 10. The DD query message includes a parameter set, which has to directly or indirectly identify a PT. The parameters could indicate, but are not limited to, PT ID or PT location associated with a store ID. In step 406, the PS accesses the Promotion Database (PDB). The PS timestamps the query message from the DD. Then the PS queries the PDB record to get the information regarding the PT that was identified in the query message from the DD. An example PDB record 800 is illustrated in FIG. 8. The PT ID in field 821 is 12356. Field 804 is used to distinguish between the same CDL of the same PT from different lots in different stores. Field 802 specifies product type promotion state discount values, which in this example are 0, 5, 15, 20, 30, 40, 50, 60 and 80(%) per day. The PT lifetime is in field 822, which is 9 days in this example. Three CDLs 841, 842 and 843 are allocated to PT 12356. All the batches within the PT lifetime are mapped in this example into three CDLs representing three price promotion selection options for PT 12356. The selection options are changed in time. The PS calculates the remaining PTM lifetime for each CDL based on the DD query timestamp and the associated CDL lot time. Then the PS maps the time to the price promotion % for each CDL indicated by the price promotion state % in field 802.

For example, a query timestamp of May 7, 2010 is mapped to a promotion of 50% for CDL 841 Blue because 3 days are left before the PTM expiration date. 20% promotion is mapped for CDL 842 Red because 6 days are left before the PTM expiration date. 0% promotion is mapped for CDL 843 Gray because 9 days are left before PTMs associated with this lot are expired.

In FIG. 4 step 407, the PS transmits message 1013 to the DD comprised of at least the PT indication, CDLs type, calculated price promotion percentages associated with each CDL and remaining PTM lifetimes associated with each CDL. In step 408, the DD displays the information from message 1013 that was sent by the PS. Other price promotion considerations together with remaining lifetimes of PTMs could be considered as well. For example, special promotion factors related to shelf space management could be taken into account. An inventory size of PTMs of a specific PT that occupies large shelf space could be utilized. Additional discounts targeting aged PTMs could be offered for these PTs to accelerate purchasing. Special promotion factors related to the introduction of a new version of a specific product type could be considered together with PTM remaining lifetime. Additional discount to accelerate the removal of old version of aged product will free shelf space for the new PT version.

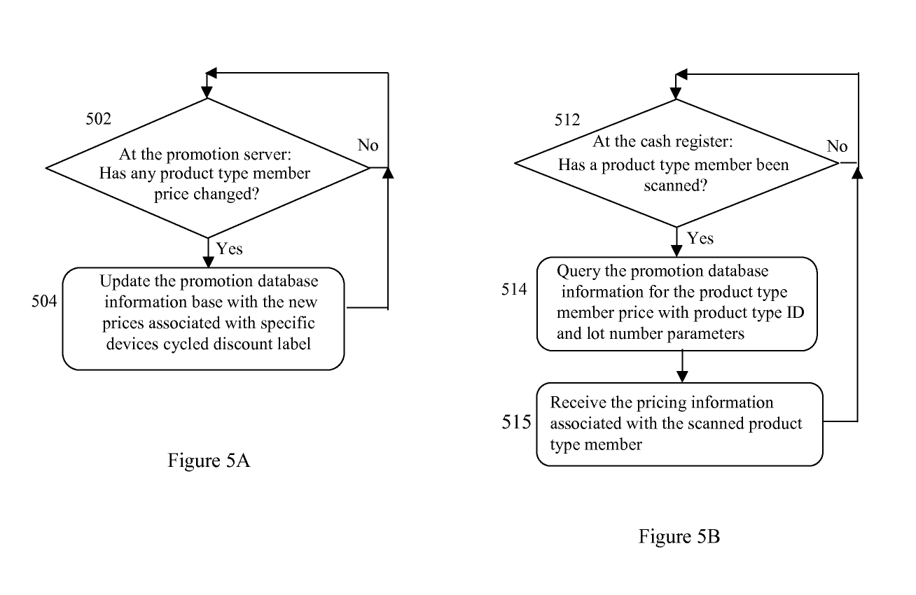

In FIG. 8, fields 823, 824 and 825 in the PDB record in this embodiment are updated as a new lot is placed on the shelves. The PS could initiate the PDB field changes. FIG. 5A illustrates an example wherein the PDB is updated with the PTM price promotion. This approach enables the CR to acquire PTM's current price promotion without performing any calculation, as illustrated in FIG. 5B. In FIG. 5A step 502, the PS monitors PTM price promotion. On any change, the PS on step 504, updates the PDB. The PTM price promotion change could be triggered by time change or by the introduction of new PTM lots. New lot updates are performed by the PIS 197 via interface 195. In another embodiment, the PIS could directly modify the PDB fields via interface 193.

In FIG. 5B on step 512, the CR waits for a PTM to be scanned. As a PTM is scanned by the CR, at least the PT ID and the lot number associated with the PTM are acquired. Both optical and RF means could be used to get this information. On step 514 of FIG. 5B the CR queries the PDB providing at least the PT ID and the lot number parameters. Message 1015, which is illustrated in FIG. 10, is used by the CR to query the PDB. Message 1016 is the response from PDB, as illustrated in FIG. 10. This message contains the price promotions for the queried PTM.

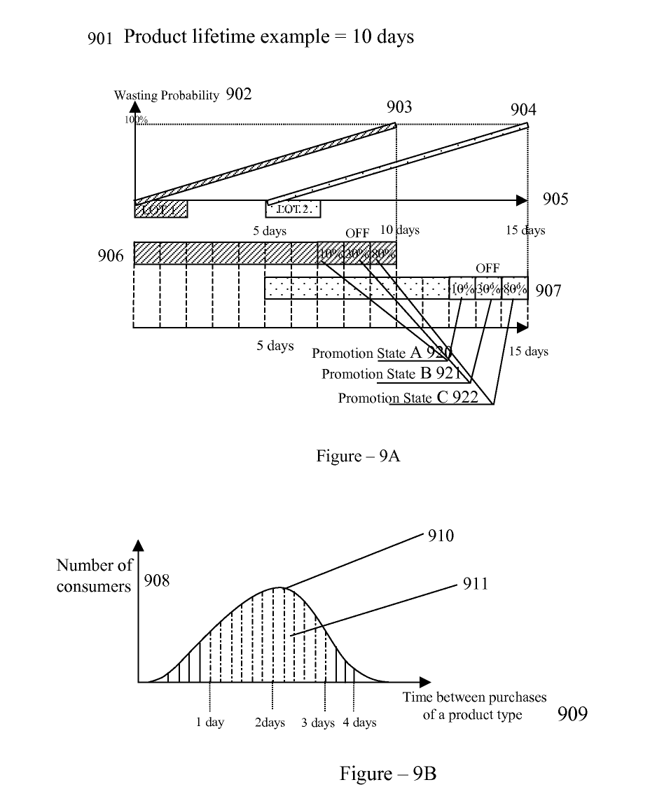

FIG. 9A and FIG. 9B illustrate an example technique to determine the number of promotional states for a specific PT based on the statistical distribution of the time between purchasing of a PT. FIG. 9B illustrates the time between purchases distribution of a PT on axis 909 versus the number of consumers on axis 908. In this example, the product lifetime 901 is 10 days. The example distribution function FIG. 9B shows that most consumers purchase this product every 2 days.

FIG. 9A illustrates a linear presentation of the PT wasting probability 903, 904 and the PSS 920, 921 and 922. Two lots of the same PT are illustrated in this example. Lot 2 in this example is produced on day 5. As the product from both lots age, the probability that they will end up as waste increases. As illustrated in FIG. 9A, this probability approaches 100% on day 15 for lot 2 and on day 10 for lot 1.

The goal is to target a large amount of consumers for higher purchasing probability shortly before a PTM is expired and wasted. Therefore, the promotion states in this example 920, 921 and 922 are at the last 3 days of the product member lifetime. This period was selected based on the consumer distribution graph illustrated in FIG. 9B. The consumers that purchase this PT every 1, 2 or 3 days can benefit from 3 promotion states as illustrated in FIG. 9B 911. At day 7, PTM prices from lot 1 are reduced by 10% (Promotion State A) because only 3 days are left before the PTMs from lot 1 expire. PTM prices from lot 2 are not reduced because 10 days are left before PTMs from lot 2 expire. At day 10, PTM prices from lot 1 are reduced by 80% (Promotion State C) because only 1 day remains before the PTMs from lot 1 expire. PTM prices from lot 2 are reduced on the 13th, 14th and 15th days accordingly as PTMs from lot 2 approaches their expiration date.

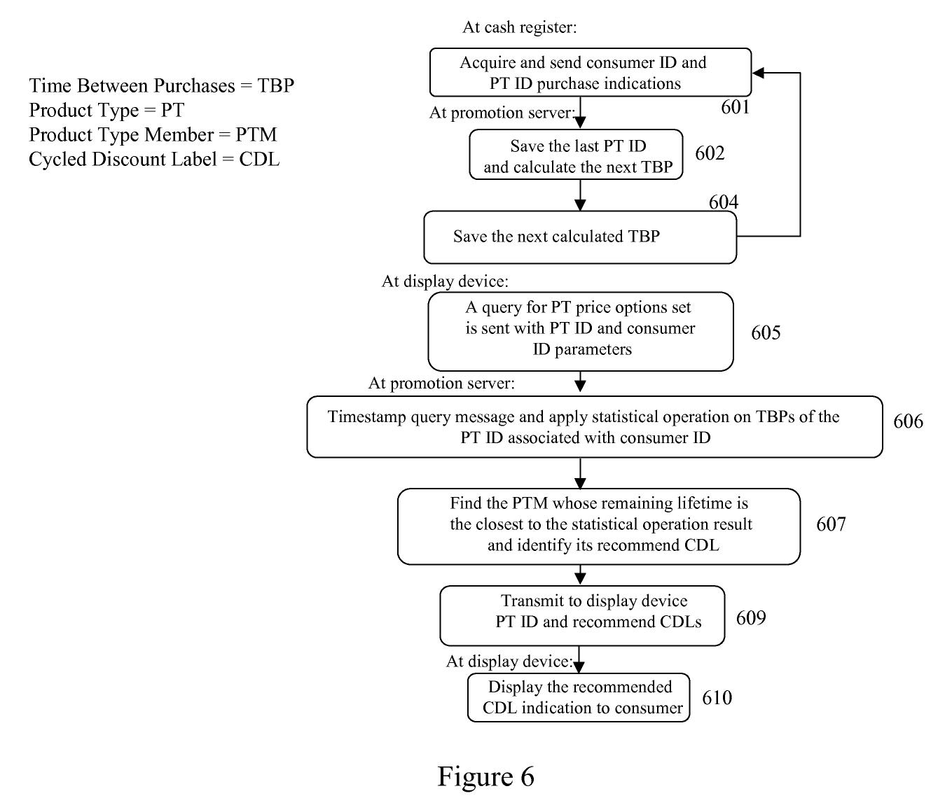

FIG. 6 illustrates a PTM purchase recommendation technique example in product price promotion system. The recommendation is customized to a specific consumer ID based on the historical time between purchases data of a specific PT. Many supermarkets provide the consumers with a personal member ID card, used for receiving special member discounts on selected products. The consumer ID card is scanned by the Cash Register (CR) before the products are scanned to be purchased.

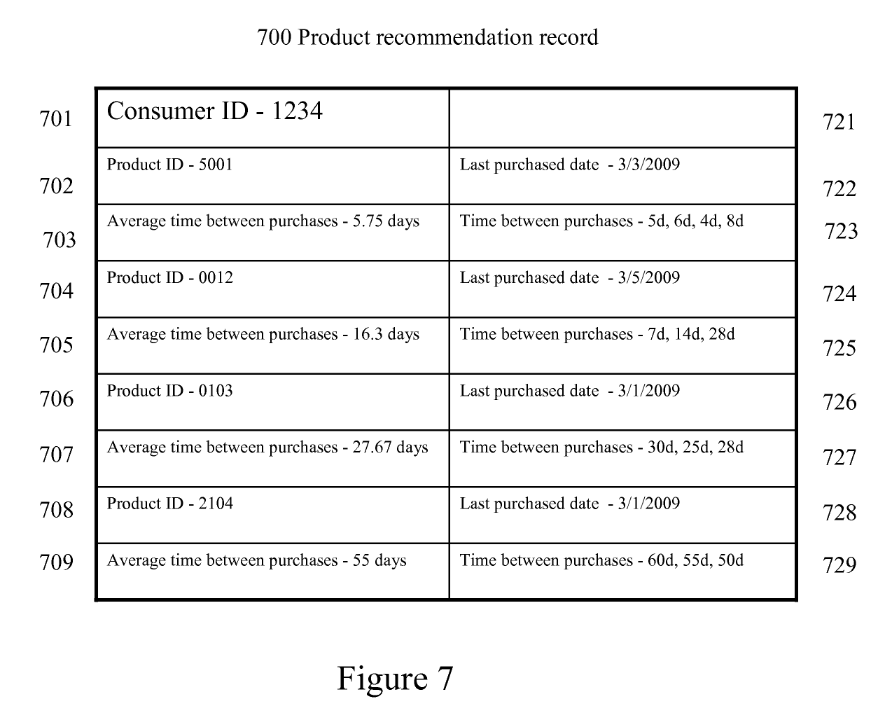

On step 601 in FIG. 6, PT IDs that were purchased by a consumer ID are acquired at the CR. The CR in this embodiment forwards the PT IDs, the consumer ID and a purchased event time to the PS 130. The PS in this example has access to a product recommendation database. FIG. 7 illustrates a record example of a product recommendation database. Field 701 in FIG. 7 is the consumer ID field. Fields 702, 704, 706 and 708 contain the PT IDs 5001, 0012, 0103 and 2104 that have been purchased by the consumer ID 1234. Fields 722, 724, 726 and 728 contain the last purchase day of the respective PT IDs by the consumer ID 1234. The time between purchase numbers for consumer ID 1234 for each respective PT ID are saved in fields 723, 725, 727 and 729.

Using an example where consumer ID 1234 purchases an item with PT ID 5001, the PS on step 602 saves the last purchased date of PT ID 5001 by consumer ID 1234. The server also calculates the time between purchases of PT ID 5001 associated with the consumer ID 1234 and saves it in the product recommendation record 700 at field 723. In this example the DD also provides the consumer ID as a parameter during price promotion options query, as illustrated in step 605.

On step 606, the PS timestamps the query message and applies statistical operation on the time between purchases data to identify the consumer's purchasing trend for PT ID 5001. Averaging is a simple statistical operation. Median statistical operation could be considered as well. Other non-linear statistical weighted approaches could also be considered. For example, applying more weight on the 10 last times between purchases of the consumer ID 1234 to capture a consumer's habit change. This change could result, for example, from an increase in the consumer's income.

Filtering out data samples that are largely deviated from other samples associated with the same PT ID 5001 and consumer ID 1234 could be also applied. The short consumption increase of PT ID 5001 could result from a temporary guests situation. FIG. 7 assumes an averaging statistical operation. In this example the statistical averaging result is stored in fields 703, 705, 707 and 709.

On step 607 in FIG. 6, the PS searches for the closest remaining lifetime of the PTM to the statistical operation result. The CDL associated with this PTM is identified by the PS as the recommended CDL. On step 609, the PS sends a message to the DD comprising the recommended CDL. On step 610, the DD shows an indication for the recommended CDL for a specific PT. Several recommended CDL indications could be sent and displayed on the DD.

I claim:

1. A method of product promotion, the method comprising:
allocating a plurality of cycled discount labels for at least one product type;
statically labeling a plurality of product type members of the product type with cycled discount labels allocated to the product type wherein each product type member of the product type and from the same lot is statically labeled with an identical cycled discount label;
dynamically calculating at least one display element which is associated with at least one cycled discount label allocated for at least one product type;
dynamically displaying on a display device, at least one product type related information, wherein the product type related information at least comprising:
at least one cycled discount label, which previously was allocated for at least one product type;
at least one promotion display element associated with each displayed cycled discount label.

2. The method of claim 1 wherein a lot is comprised of one or more production or pickup batches of product type members of the same product type.

3. The method of claim 1 wherein an identical cycled discount label of at least a first product type member of the first product type and from the first lot is reused for at least a second product type member of the first product type and from the second lot, as long as the time period between the first lot and the second lot is equal or greater than the first product type lifetime

4. The method of claim 1 wherein the number of cycled discount labels allocated for a product type is greater than 1

5. The method of claim 1 wherein the number of cycled discount labels allocated for a product type is greater than 2 and a specific cycled discount label is used only for one lot during a lifetime of a product type and the following expiration period of the lot associated with the specific cycled label

6. The method of claim 5 wherein cycled discount labels indicating the expiration period of a lot are used for product type members from different lots

7. The method of claim 1 wherein the display device is stationary

8. The method of claim 1 wherein the display device is mobile

9. The method of claim 1 wherein the display device is a passive permanent printed display

10. A method of product promotion, the method comprising:
at the promotion server:
receiving a query with parameter set for promotion options associated with at least one cycled discount label allocated to at least one product type;
calculating at least the promotion options associated with at least one cycled discount label allocated for at least one product type;
transmitting a message to a stationary or mobile display device comprising:
at least a subset of cycled discount labels allocated to at least one product type;
at least one promotion option of at least one group of product type members associated with a subset of cycled discount labels allocated to at least one product type;
if at list one promotion option changes to a new promotion option or at least one promotion option is added, then the promotion database is updated with at least one new promotion option

11. The method of claim 10 wherein the calculation of the promotion of product type members associated with a cycled discount label is at least determined by the time difference between a query timestamp and the expiration date of at least one product type member associated with the same cycled discount label

12. The method of claim 10 wherein the calculation of promotion numbers, levels and starting times is determined by a statistical distribution data of the time between purchases of the product type and the probability of at least one product type member to expire

13. The method of claim 10 wherein the query to the promotion server is triggered by location change of the display device

14. The method of claim 10 wherein the query to the promotion sever is manually triggered

15. The method of claim 13 wherein the location change of a display device is determined by comparing a first RF signal indicating the location of the first RF device and a second RF signal indicating the location of the second RF device

16. The method of claim 10 wherein the parameter set of a query comprises at least product type ID or a location indication of the product type

17. The method of claim 10 wherein the query parameter set comprises at least a location indication of the display device and store ID

18. The method of claim 17 wherein the location of a display device is determined by the product type ID and the store ID, wherein the product type is in proximity to the display device

19. A method of claim 18 wherein the first store ID and the second store ID are further used to distinguish between lots with the same cycled label in the first and second stores

20. The method of claim 16 wherein the product type ID is determined by an RF device transmission comprises at least product type ID

21. The method of claim 20 wherein the RF device transmission further contains store ID

22. The method of claim 16 wherein the product type ID is determined by reading an optical code

23. The method of claim 16 wherein a product type location indication is determined by an RF transmission content of an RF device in proximity to the product type location.

24. The method of claim 10 wherein the calculation of promotion options of product type members of product types associated with at least one cycled discount labels is based on:
special promotion factors related to inventory management or shelf space management or special promotion factors related to the introduction of a new versions of product types

25. The method of claim 10 wherein the receiving and transmitting protocols to and from the promotion server are based on Internet protocols

26. The method of claim 10 wherein the promotion database or the promotion server is queried by the cash register system for promotion information of product type members

27. A method of recommending a product type members purchasing comprised of steps:
acquiring at least the first purchasing event time of at least the first product type by at least first consumer;
acquiring at least the second purchasing event time of at least the first product type by at least first consumer;
calculating the time between the first and the second purchasing events of at least the first product type by at least the first consumer;
storing the time between the purchases of at least the first product type by at least the first consumer;
receiving a query for promotion options providing of at least the first consumer ID;
applying timestamp on the query;
applying statistical operation on the time between purchases data of the at least the first product type by the first consumer;
searching for at least the first product type member of the first product type wherein its remaining lifetime between the query timestamp and the first product type member expiration date is the closest to the statistical operation result of the time between purchases data of at least the first product type by the first consumer;
identifying at least one cycled discount label associated with the first product type member of the first product type as the recommended cycled discount label;
sending a message to the display device comprised of:
at least one recommended cycled discount label for first product type;
displaying a recommendation representation that points to at least one recommended displayed cycled discount label of at least the first product type

28. The method of claim 1 wherein the cycled discount labels are selected from different colors

29. The method of claim 1 wherein the cycled discount labels are selected form different patterns or shapes

30. The method of claim 1 wherein the cycled discount labels are selected form a combination of different color, patterns or shapes

31. The method of claim 1 wherein the product type related information further comprising: at least one product type representation

32. The method of claim 1 wherein the product type related information further comprising:
at least one display element which is related to the remaining life time of the product type members associated with at least one of the displayed cycled discount label

33. The method of claim 10 wherein the query to the promotion server is triggered by promotion change of at least one product type member
